(19) United States
(12) Patent Application Publication
(10) Pub. No.: US 2020/0386363 A1
(43) Pub. Date: Dec. 10, 2020

(54) Piping insulation with improved protection mechanism

(71) Applicant: Venti Air Products, LLC, Houston, TX (US)

(72) Inventor: Amitabh Agarwala, Houston, TX (US)

(73) Assignee: Venti Air Products, LLC, Houston, TX (US)

(21) Appl. No.: 16/891,955

(22) Filed: Jun. 3, 2020

Related U.S. Application Data
(60) Provisional application No. 62/857,354, filed on Jun. 5, 2019.

(51) Int. Cl. F16L 59/10; F16L 59/02

(52) U.S. Cl. CPC F16L 59/10; F16L 59/026

(57) ABSTRACT

A piping insulation with improved protection mechanism is provided for protecting the insulating material from mechanical damage and providing additional UV protection which includes a primary insulation body having a passage therethrough along a primary insulation body centerline, a durable covering encircling the primary insulation body, and a fastening mechanism using hook and loop material configured to withstand stresses resulting from a difference of a primary insulation body elasticity and a durable covering elasticity.

### CROSS-REFERENCE TO RELATED APPLICATIONS

This application claims the benefit of and priority to U.S. Provisional Patent Application No. 62/857,354, filed Jun. 5, 2019 for “Piping Insulation with Improved Protection Mechanism” which is incorporated by reference.

### STATEMENT REGARDING FEDERALLY SPONSORED RESEARCH OR DEVELOPMENT

Not Applicable.

### BACKGROUND

### Field

The present disclosure relates to the field of insulation system for tubing/piping for the air conditioning and refrigeration systems. More particularly, the present disclosure relates to a system for protecting the insulating material from environmental damage, common household chemicals, limited mechanical damage and providing long term UV protection. It also provides for protection of liquid line and wire in an air conditioning and/or refrigeration system.

### Description of the Related Art

Piping insulation is intended to provide thermal protection to the enclosed piping, reducing the temperature change of the fluid or gas being transmitted. However, such materials are susceptible to damage from the surrounding spaces, including environmental degradation, accidental damage from lawn equipment, and contact from objects positioned nearby or which fall onto the insulating material. Various solutions have been attempted to remedy this, including insulating cushions with hooks, jackets and tape, glued or particularly stitched along the edge of a flap and use of external hard piping.

It would be an improvement to provide a system for protection of insulating material from environmental damage, common household chemicals and limited mechanical damage and provide additional long-term UV protection, particularly using a hook-and-loop material that can withstand stress created by elasticity difference of a flexible foam core and a protective durable covering. The hook and loop for fastening mechanism also allows for protection of copper liquid line and wire besides ease of installation in existing systems without dismantling them.

### SUMMARY

The present disclosure therefore meets the above needs and overcomes one or more deficiencies in the prior art by providing a piping insulation system with improved protection mechanism.

The disclosure provides a piping insulation for protecting the insulating material from mechanical damage which includes a primary insulation body; a durable covering; and a fastening mechanism; wherein said durable covering encircles said primary insulation body, said durable covering configured to withstand stress, environmental damage, exposure to household chemicals, and ultraviolet light damage; said primary insulation tubing having a passage therethrough along a primary insulation body centerline; said fastening mechanism using hook and loop material configured to withstand stresses resulting from a difference of a primary insulation body elasticity and a durable covering elasticity; said hook and loop also material allows for protection of copper liquid line and wire in an air-conditioning or refrigeration system; and said hook and loop-material allows for ease of installation in existing systems without dismantling them.

The disclosure further provides a piping insulation system for separate encapsulation of a piping and a wiring and any second piping in a single body which includes a primary insulation body having an interior passage therethrough along a primary insulation body centerline, a jacket having a jacket width from a jacket first end to a jacket second end less than an outer perimeter of the primary insulation body and adhered to a primary insulation exterior surface, a cover flap attached to the jacket at a flap first end to a jacket second end and extending from the jacket second end, the flap having a first hook-and-loop member on a flap underside at a flap second end, the cover flap having a flap width from the flap first end to the flap second end, a second connecting hook-and-loop member on a jacket outer side at the jacket first end, a shortest distance from the jacket first end to the jacket second end less than the a flap width from the flap first end to the flap second end.

Additional aspects, advantages, and embodiments of the disclosure will become apparent to those skilled in the art from the following description of the various embodiments and related drawings.

### BRIEF DESCRIPTION OF THE DRAWINGS

So that the manner in which the described features, advantages, and objects of the disclosure, as well as others which will become apparent, are attained and can be understood in detail; more particular description of the disclosure briefly summarized above may be had by referring to the embodiments thereof that are illustrated in the drawings, which drawings form a part of this specification. It is to be noted, however, that the appended drawings illustrate only typical embodiments of the disclosure and are therefore not to be considered limiting of its scope as the disclosure may admit to other equally effective embodiments.

In the drawings:

FIG. 1 illustrates a side view of the disclosure.

FIG. 2 illustrates a top view of the disclosure.

FIG. 3 illustrates orthogonal view of the disclosure with open flap.

FIG. 4 illustrates the orthogonal view of the disclosure with open flap but with slit in the foam insulation.

### DETAILED DESCRIPTION OF THE INVENTION

The following detailed description refers to the accompanying drawings, which illustrate specific embodiments. Other embodiments having different structures and operation do not depart from the scope of the present disclosure.

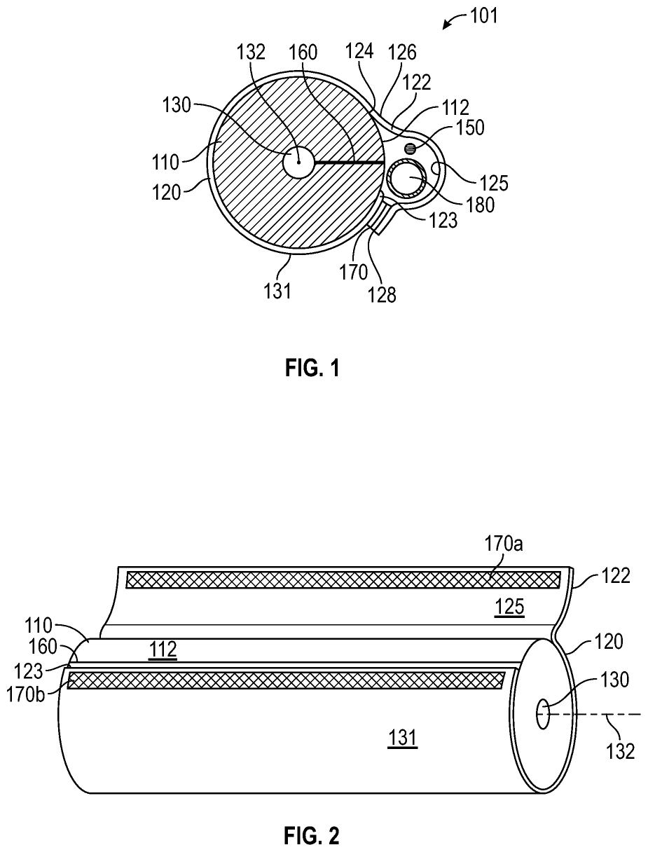

Referring to FIG. 1, a side view of the disclosure is illustrated. The disclosure includes a piping insulation system 101 for protecting the insulating material from mechanical damage including a primary insulation body 110, a durable covering 120, and a fastening mechanism 170. The durable covering 120 encircles the primary insulation body 110 and is configured to withstand stress, environmental damage, exposure to household chemicals, and ultraviolet light damage. The durable cover 120 may include a cover flap 140. The primary insulation body 110 has a passage 130 therethrough along a primary insulation body centerline 132. The fastening mechanism 170 may use a hook and loop material configured to withstand stresses resulting from a difference of an elasticity of the primary insulation body and the elasticity of the durable covering elasticity. FIG. 1 thus shows the primary insulation body 110, which may be an elastomeric closed cell foam pipe insulation with a hollow core in the center, where the primary insulation body 110 may be provided in a solid tubular form with a hollow center or with slit along its length.

The primary insulation body 110 may be composed of a flexible elastomeric closed cell pipe insulation. The primary insulation body 110 may be provided in a tubular form, black in color and may generally be characterized as a foam insulation. The primary insulation body 110 may be provided in any of several thicknesses. The passage 130 likewise may be provided in any one of several different diameters. The primary insulation body 110 may be elastomeric closed cell foam pipe insulation, foam rubber or any foam or insulating material.

The durable covering 120 is preferably a durable fluorocarbon fiberglass cover. The fluorocarbon and fiberglass impart qualities UV resistance, waterproofing, resistance to household chemicals, mineral acids, salt solutions, chlorinated hydrocarbons and petroleum oils, and tensile strength to the durable covering 120. The durable covering 120 may provide protection against UV rays, water, household chemicals, mineral acids, salt solutions, chlorinated hydrocarbons and petroleum oils, and mechanical damage. The durable covering 120 is glued to the primary insulation body 110 about the exterior of the primary insulation body 110 and extends past with the cover flap 122, and thus provides a flap to cover components, such as any copper liquid line 180 and wire 150 in an air-conditioning or refrigeration system. Any wire 150 associated with the system may sit on top of the primary insulation body 110 but underneath the cover flap 122.

The passage 130 provides a hollow core in the center of the primary insulation body 110.

The cover flap 122 extends from the durable covering 120 and may be part of the durable covering 120 or may be a separate body attached thereto or to the primary insulation body 110 to provide different properties.

Using a hook-and-loop material as the fastening mechanism 170 provides advantages over conventional systems. In use, the differences in the elasticity of primary insulation body 110 and durable covering 120 as well as the need to partially open and close the durable covering 120 to install any liquid line copper tubing 180 and wire 150 frustrates use of mere adhesives. A fastening mechanism 170 of hook-and-loop construction allows for protection of copper liquid line and wire as well as ease of installation.

The primary insulation body 110 may include a slit 160 therethrough to the passage 130. With a slit 160, the primary insulation body 110 permits ease of installation in existing systems without dismantling them. The slit 160 may be introduced during manufacture or during installation.

The present disclosure may thus provide for protection of copper tubing (suction line and liquid line) and wire in air conditioning, refrigeration system, steel and/or PVC pipes for plumbing, lawn sprinklers, irrigation or any other such kind. The disclosure may use foam insulation core as primary insulation.

Referring to FIG. 2, a top view of the disclosure as installed is illustrated. The durable covering 120 is shown with the cover flap 122 unattached. The primary insulation body 110 with a passage 130 and durable covering 120 may be positioned to surround a copper tubing or pipe (now shown).

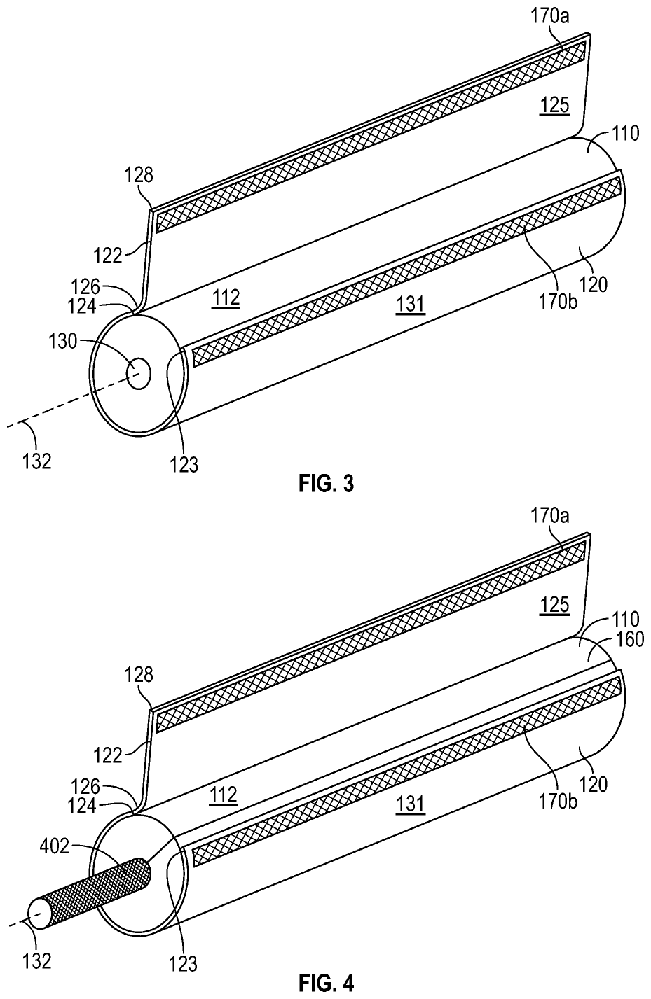

Referring to FIG. 3, an orthogonal view of the disclosure with an open cover flap 122 is illustrated.

Referring to FIG. 4, an orthogonal view of the disclosure is provided with an open cover flap 122 and slit 160 in the primary insulation body 110 when a piping 402 is encapsulated in the passage 130. The slit 160 is ultimately covered by the cover flap 122 to ensure exclusion of materials which might otherwise damage the insulated components and to provide some rigidity against mechanical damage. The disclosure thus provides for protection of insulating material from environmental damage, common household chemicals and limited mechanical damage and provide additional long-term UV protection.

Thus, the disclosure provides a piping insulation system 101 for separate encapsulation of a piping 402 and a wiring 150 and any second piping 180 in a single body which includes a primary insulation body 110 having an interior passage 130 therethrough along a primary insulation body centerline 132, a jacket 120 having a jacket width from a jacket first end 123 to a jacket second end 124 less than an outer perimeter of the primary insulation body 110 and adhered to a primary insulation exterior surface 112, a cover flap 122 attached to the jacket 120 at a flap first end 126 to a jacket second end 124 and extending from the jacket second end 124, the flap having a first hook-and-loop member 170 on a flap underside 125 at a flap second end 128, the cover flap 122 having a flap width from the flap first end 126 to the flap second end 128, a second connecting hook-and-loop member 170 on a jacket outer side 131 at the jacket first end 123, a shortest distance from the jacket first end 123 to the jacket second end 124 less than the a flap width from the flap first end 126 to the flap second end 128.

The present invention provides a system and method to provide a unique system and method for protecting the insulating material from limited mechanical damage, environmental damage, resistance to household chemicals and provide long term UV protection. Environmental damage consists of damage to season temperature changes, rain, water and UV exposure. The durable covering resists wide range of seasonal temperature changes and is waterproof. A fluorocarbon coated fiberglass provides a durable covering which provides sufficient ultraviolet (“UV”) protection. The durable coverings may be used for installation outside in the residential and commercial applications. The fluorocarbon durable covering may provide protection from mineral acids, salt solutions, chlorinated hydrocarbons and petroleum oils. The durable covering has tensile strength and provides limited resistance to mechanical damage. The insulating core may be composed of a closed-cell elastomeric foam. The apparatus does not degrade the insulation R-values of the foam insulation.

Fluorocarbon fiberglass fabric provides superior performance over coverings of rubber, HDPE, vinyl and acrylic and can provide long term weatherproofing, UV resistance and tensile strength. The covering is installed at the factory by gluing it to the foam insulation at the factory eliminating the need to install it on location by untrained personnel. Finding the ideal glue presented its challenges because the apparatus needed to withstand extreme weather conditions and joined two materials with vastly different physical properties. Development of the ideal glue that can provide perfect adhesion under extreme weather conditions is still work in progress.

In operation, any tubing positioned in the passage 130 is protected by the durable covering 120 to withstand stress, environmental damage, and resistance to household chemicals and provide long term UV protection. Beneficially, the present disclosure may provide the same, or event greater, R-value as conventional foam rubber insulation. R-value is the measurement of a material's capacity to resist heat flow from one side to the other. In simple terms, R-values measure the effectiveness of insulation and a higher number represents more effective insulation. The durable covering 120 retains or enhances insulation properties.

In the absence of the slit 160, the primary insulation body 110 with a passage 130 is slipped over any tubing. When the primary insulation body 110 includes the slit 160, the piping insulation system 101 can be installed without attempting to drive the piping insulation system 101 along a tubing. The fastening mechanism 170 using a hook-and-loop material allows usage over both, slit and non-slit type of primary insulation body 110, as illustrated in FIG. 2. The primary insulation body 110 can be slit along the length for the ease of installation but the slit 160 must covered by the hook-and-loop material to maintain the integrity of the protection. Hook-and-loop material also provides ease of installation regardless whether a slit 160 is used. The use of hook-and-loop material allows insertion and protection of liquid line tubing and wiring, such as thermostat wiring.

The foregoing disclosure and description is illustrative and explanatory thereof. Various changes in the details of the illustrated construction may be made within the scope of the appended claims without departing from the spirit of the invention. The present invention should only be limited by the following claims and their legal equivalents.

What is claimed is:

1. A piping insulation system for protecting the insulating material from mechanical damage comprising:
a primary insulation body;
a durable covering; and
a fastening mechanism;
wherein said durable covering encircles said primary insulation body and includes a flap,
said durable covering configured to withstand stress, environmental damage, exposure to household chemicals, and ultraviolet light damage;
said primary insulation tubing having a passage therethrough along a primary insulation body centerline; and
said fastening mechanism using hook and loop material configured to withstand stresses resulting from a difference of a primary insulation body elasticity and a durable covering elasticity.

2. The piping insulation system of claim 1, wherein the primary insulation body is elastomeric closed cell foam pipe insulation.

3. A piping insulation system, comprising:
a primary insulation body having an interior passage therethrough along a primary insulation body centerline;
a jacket having a jacket width from a jacket first end to a jacket second end less than an outer perimeter of the primary insulation body and adhered to a primary insulation exterior surface,
a flap attached to the jacket at a flap first end to the jacket second end and extending from the jacket second end,
the flap having a first hook-and-loop member on a flap underside at a flap second end,
the flap having a flap width from the flap first end to the flap second end; and
a second connecting hook-and-loop member on a jacket outer side at the jacket first end;
where a shortest distance from the jacket first end to the jacket second end is less than the flap width.
